(19) United States
(12) Patent Application Publication
(10) Pub. No.: US 2025/0120351 A1
(43) Pub. Date: Apr. 17, 2025

(54) POTTING MIX WITH GLASS FIBERS

(71) Applicant: Owens Corning Intellectual Capital, LLC, Toledo, OH (US)

(72) Inventors: David H. Wolf, Newark, OH (US); Richard Norris Dodge, II, Appleton, WI (US)

(21) Appl. No.: 18/908,134

(22) Filed: Oct. 7, 2024

Related U.S. Application Data
(60) Provisional application No. 63/590,074, filed on Oct. 13, 2023.

(51) Int. Cl. A01G 24/18; A01G 24/25; A01G 24/28; A01G 24/42

(52) U.S. Cl. CPC A01G 24/18; A01G 24/25; A01G 24/28; A01G 24/42

(57) ABSTRACT

Loose growing media, such as potting mixes, that support the growth of plants and crops are disclosed. At least a portion of a natural component (e.g., peat, coir) of the potting mix is replaced with a man-made component in the form of a fiberglass material.

### CROSS-REFERENCE TO RELATED APPLICATION(S)

This application claims priority to and any benefit of U.S. Provisional Application No. 63/590,074, filed Oct. 13, 2023, the content of which is incorporated herein by reference in its entirety.

### FIELD

The general inventive concepts relate to potting mixes and, more particular, to potting mixes that include a quantity of glass fibers therein.

### BACKGROUND

A potting mix, also known as “potting soil” or “soilless growing media,” is a substrate used to grow plants in containers. Normal soil (dirt) is often a poor growing media since it tends to become compacted and lose pore space after repeated waterings. Conventional potting mixes often include a mix of organic and inorganic ingredients. Common materials used in potting mixes include peat, coconut coir, and wood products (e.g., bark and fiber). Other conventional ingredients include stone wool, recycled paper, coarse sand, vermiculite, and calcined clays.

A potting mix will generally provide water transport, retention, and drainage. Ensuring that the roots of a plant have access (over time) to water introduced in the mix is critical to plant growth. Aeration is another important feature, as the roots of a plant also need oxygen to grow. Furthermore, the potting mix should provide sufficient structural support to the growing plant, while avoiding any substances that might be toxic to the plant.

While peat is a particularly effective ingredient in many potting mixes, it presents a sustainability challenge in that the peat comes from peatlands. Harvesting peat moss threatens the plant and animal species found in peatlands. Furthermore, as carbon sinks, disturbing peatlands can result in CO₂ being released into the atmosphere, which contributes to global climate change. Consequently, coir (i.e., a natural fiber extracted from the outer husk of a coconut) is often used in place of peat in potting mixes. However, coir has a large concentration of electrolytes (i.e., salts), which could be toxic to plants. To address the high levels of sodium and potassium therein, the coir must be processed (e.g., washed, buffered) prior to being introduced into the potting mix.

In view of the above, it is proposed to replace a portion of the natural bulking material (e.g., peat, coir, or similar ingredient) in a potting mix with glass fibers.

### SUMMARY

In view of the above, inventive potting mixes, as well as systems for and methods of using the inventive potting mixes to promote plant growth in a container, are provided. The inventive potting mixes include a quantity of glass fibers therein. The inventive fiberglass-based potting mixes achieve comparable or better results than conventional peat-based or coir-based potting mixes, and do so at a reduced cost, at a reduced mass or density, and/or while avoiding one or more drawbacks associated with the conventional approaches and materials.

In some exemplary embodiments, a soilless growing media comprises a blend of a quantity of a natural material and a quantity of a fiberglass material.

In some exemplary embodiments, a ratio of the natural material to the fiberglass material is in the range of 1:4 to 4:1 by volume.

In some exemplary embodiments, a ratio of the natural material to the fiberglass material is about 7:3 by volume.

In some exemplary embodiments, a ratio of the natural material to the fiberglass material is about 1:1 by volume.

In some exemplary embodiments, the natural material is peat.

In some exemplary embodiments, the natural material is coconut coir.

In some exemplary embodiments, the fiberglass material is in the form of a plurality of discrete nodules of glass lacking a silicone emulsion.

In some exemplary embodiments, an average diameter of the fibers of the fiberglass material is in the range of 1 μm to 5 μm.

In some exemplary embodiments, the soilless growing media is able to hold an increased amount of available water (EAW and/or WBC) from 1-5 kPa and/or from 1-10 kPa, as compared to an otherwise identical soilless growing media comprising only the natural material (i.e., none of the fiberglass material).

In some exemplary embodiments, the soilless growing media is able to hold a decreased amount of unavailable water (UW) from ≥10 kPa, as compared to an otherwise identical soilless growing media comprising only the natural material (i.e., none of the fiberglass material).

In some exemplary embodiments, the soilless growing media exhibits an increased hydraulic conductivity from 10 kPa to 40 kPa as compared to an otherwise identical soilless growing media comprising only the natural material (i.e., none of the fiberglass material).

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

The general inventive concepts, as well as embodiments and advantages thereof, are described below in greater detail, by way of example, with reference to the drawings in which:

FIG. 1 is a table illustrating the results of a “dry bulk density” trial.

FIG. 2 is a table illustrating the results of a “wet bulk density” trial.

FIG. 3 is a table illustrating the results of a “porosity” trial.

FIG. 4 is a table illustrating the results of a “pH” trial.

FIG. 5 is a table illustrating the results of an “electrical conductivity (EC)” trial.

FIG. 6 is a table illustrating the results of a “phytotoxicity” trial.

FIG. 7 is a table illustrating the results of another “phytotoxicity” trial.

FIG. 8 is a table illustrating the results of a “peat, plant growth” trial.

FIG. 9 is a table illustrating the results of a “peat, water stress” trial.

FIG. 10 is a table illustrating the results of a “coir, plant growth” trial.

FIG. 11 is a table illustrating the results of a “coir, water stress” trial.

FIG. 12 is a diagram of a test device used to generate the data presented in FIGS. 13-14.

FIG. 13 is a graph of the data from a “peat, top hydration” trial.

FIG. 14 is a graph of the data from a “coir, top hydration” trial.

FIG. 15 is a diagram of a test device used to generate the data presented in FIGS. 16-17.

FIG. 16 is a graph of the data from a “peat, bottom hydration” trial.

FIG. 17 is a graph of the data from a “coir, bottom hydration” trial.

FIG. 18 is a diagram illustrating fiberglass nodules of two different sizes.

FIG. 19 is a diagram illustrating the impact of the nodules of FIG. 18 in growing media.

FIGS. 20A-2C are graphs of the data from a “moisture retention” trial for three control samples with different initial moisture contents, respectively.

FIG. 21 is a graph of the data from a “hydraulic conductivity” trial (unsaturated media).

### DETAILED DESCRIPTION

Unless defined otherwise, all technical and scientific terms used herein have the same meanings as commonly understood by one of ordinary skill in the art to which this invention belongs. The term “about,” as used herein to modify any numerical values, encompasses the specific numerical value(s) without any modification, as well as reasonable deviations therefrom, such as those attributable to measurement methodologies or limitations.

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

The general inventive concepts encompass potting mixes that include a significant portion (e.g., >10% by volume; at least 20% by volume, or more) of glass fibers. Such potting mixes differ from conventional potting mixes, for example, by replacing a primary natural component (e.g., peat, coir) with a man-made fibrous component and, in particular, glass fibers. Unlike properties of natural materials (e.g., peat, coir), properties of glass fibers are readily controllable, which allows for a potting mix with properties that can be tuned, for example, for a particular plant-type. As another example, tuning the properties of the glass fibers can allow the glass fibers to achieve synergy with and/or make up for any shortcomings of other components with which the glass fibers will be joined to form the potting mix.

Several trials were conducted to assess the ability of glass fibers to function as a viable substitute for a portion (e.g., >30% by volume) of the peat and/or coir used to grow plants in a container.

In the trials, ten (10) samples were evaluated, as detailed in Table 1 below.

TABLE 1

| Sample # | Component A | | Component B |
|---|---|---|---|
| 1 | 100% | peat | — |
| 2 | 70% | peat | 30% FG-1X |
| 3 | 50% | peat | 50% FG-1X |
| 4 | 70% | peat | 30% FG-10X |
| 5 | 50% | peat | 50% FG-10X |
| 6 | 100% | coir | − |
| 7 | 70% | coir | 30% FG-1X |
| 8 | 50% | coir | 50% FG-1X |
| 9 | 70% | coir | 30% FG-10X |
| 10 | 50% | coir | 50% FG-10X |

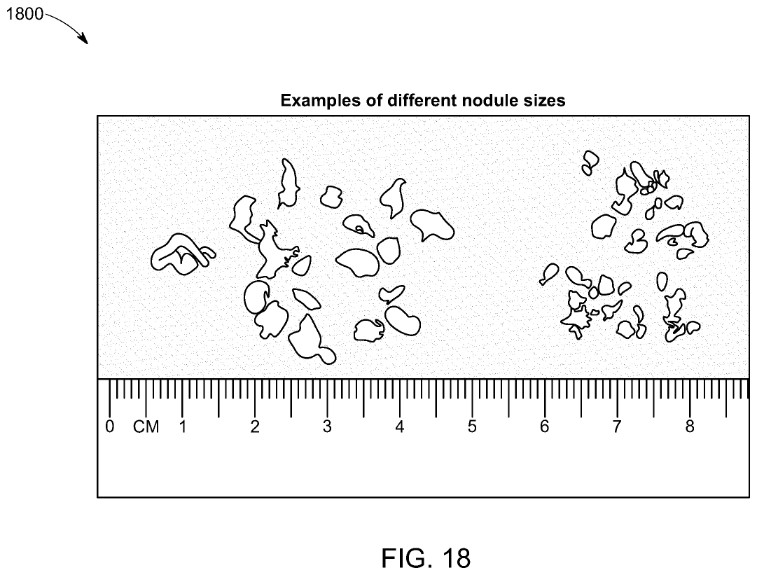

The peat for samples 1-5 was commercially sourced from Premier Tech Ltd. of Quebec, Canada, and marketed as Premier Peat Moss (describing its contents as Canadian sphagnum peat moss). The coir for samples 6-10 was commercially sourced from Envelor Corp. of Edison, New Jersey, and marketed as Buffered Coco Coir (describing its contents as a soil mix blending natural coco fibers and the appropriate amounts of nutrients). The FG-1X material for samples 2-3 and 7-8 was prepared by passing unbonded loosefill (ULF) fiberglass produced by Owens Corning of Toledo, Ohio through a commercial loosefill blowing machine one (1) time to condition the ULF. The FG-10X material for samples 4-5 and 9-10 was prepared by passing the same ULF material through the same commercial loosefill blowing machine ten (10) times to increase the conditioning of the ULF. In general, the number of times the ULF is passed through the commercial loosefill blowing machine tends to condition the fiberglass nodules/tufts from a coarser state to a finer state, which can generally alter the average nodule size (see FIG. 18). The loosefill blowing machine was produced by CertainTeed LLC of Malvern, Pennsylvania, and sold as the CertainTeed Volu-Matic III. The glass fibers of both the FG-1X and FG-10X materials were produced with a target diameter of about 3 μm, with a distribution that ranges from submicron to 10 μm.

The ULF material used to form the FG-1X and FG-10X materials did not include any silicone emulsion on its surface, as would typically be found on conventional ULF fibers used in insulation products. The FG-1X and 10X materials did include small amounts of mineral oil (i.e., about 0.10 wt. %) and a polyamine cationic lubricant (i.e., about 0.01 wt. %) applied to their surfaces to help with lubrication (reducing dust) while not creating hydrophobicity.

Similarly, to produce the sample mixtures (i.e., blends) of the fiberglass materials and the natural materials, the fiberglass materials (i.e., FG-1X or FG-10X) were proportioned on a volume basis with the natural materials (i.e., peat or coir) and then blended pneumatically by passing the components through a loosefill insulation blowing machine, such as that described above. Other forms of blending that adequately mix the components without clumping or segregation are expected to produce similar results.

In one trial, the dry bulk density was measured across the growth substrate samples. The dry bulk density of the samples was calculated by Equation 1.

$${p}_{b} = \frac{{M}_{s}}{{V}_{t}} \qquad Equation ( 1 )$$

where ρ_{b} is the dry bulk density of the growth substrate, Mₛ is the mass of the growth substrate in grams (g), and Vₜ is the total volume occupied by the growth substrate in cubic centimeters (cm³).

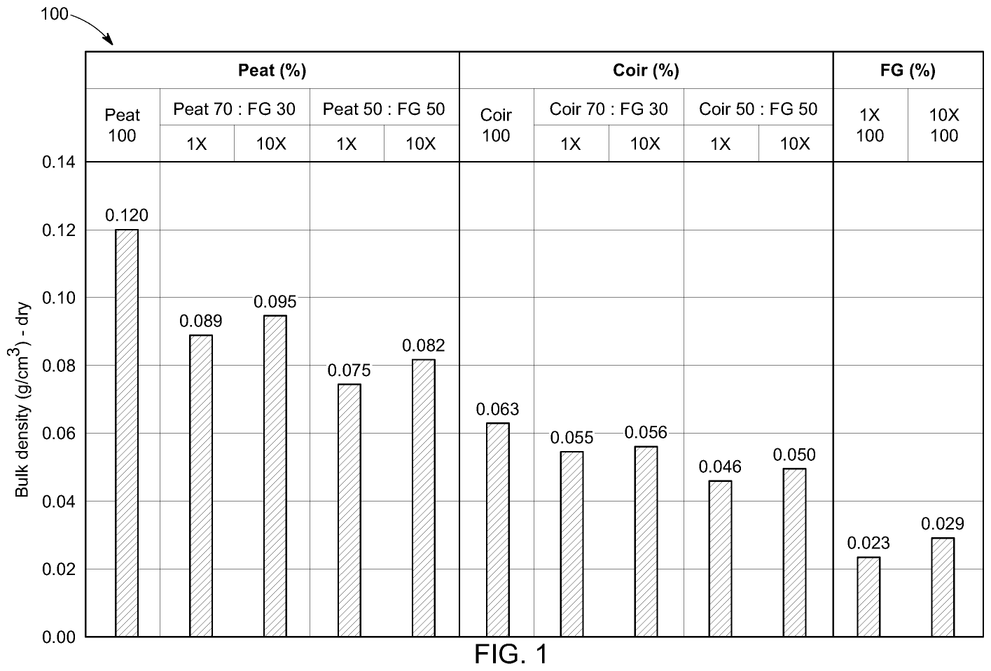

The results of the “dry bulk density” trial are shown in the Table 100 of FIG. 1. The 100% peat sample was measured to have a dry bulk density of approximately 0.120 g/cm³. Conversely, replacing a portion of the peat with fiberglass was shown to lower the dry bulk density. In particular, both the 70% peat with 30% fiberglass blends (0.089 g/cm³; 0.095 g/cm³) and the 50% peat with 50% fiberglass blends (0.075 g/cm³; 0.082 g/cm³) exhibited lower dry bulk densities.

The 100% coir sample was measured to have a dry bulk density of approximately 0.063 g/cm³. Similarly, replacing a portion of the coir with fiberglass was shown to lower the dry bulk density. In particular, both the 70% coir with 30% fiberglass blends (0.055 g/cm³; 0.056 g/cm³) and the 50% coir with 50% fiberglass blends (0.046 g/cm³; 0.050 g/cm³) exhibited lower dry bulk densities.

The use of the fiberglass was shown to be an effective component at lowering the dry bulk density and, thus, the dry weight of the growth substrate. This is likely because the dry bulk density of both the coarser nodules FG-1X (0.023 g/cm³) and the finer nodules FG-10X (0.029 g/cm³) is much lower than the dry bulk density of the peat (0.120 g/cm³) and the coir (0.063 g/cm³). For further comparison, wood fibers and mineral wool fibers typically have a bulk density much greater than that of the glass fibers (e.g., FG-1X and FG-10X).

It is also worth noting that the glass fibers, unlike the peat, coir, and wood fibers, are not hygroscopic. Thus, in another trial, the wet (or “as-is”) bulk density was measured across the growth substrate samples. The wet bulk density includes the hygroscopic moisture content of the natural components of the samples, which better represents the “actual use” condition of the growth substrates. The wet bulk density of the samples was calculated by Equation 2.

$${ρ}_{t} = \frac{{M}_{t}}{{V}_{t}} \qquad Equation ( 2 )$$

where ρₜ is the wet bulk density of the growth substrate, Mₜ is the mass of the growth substrate and its moisture content in grams (g), and Vₜ is the total volume occupied by the growth substrate in cubic centimeters (cm³). The moisture fraction of the peat was 45% and the moisture fraction of the coir was 80% (i.e., water mass fraction of the moist media).

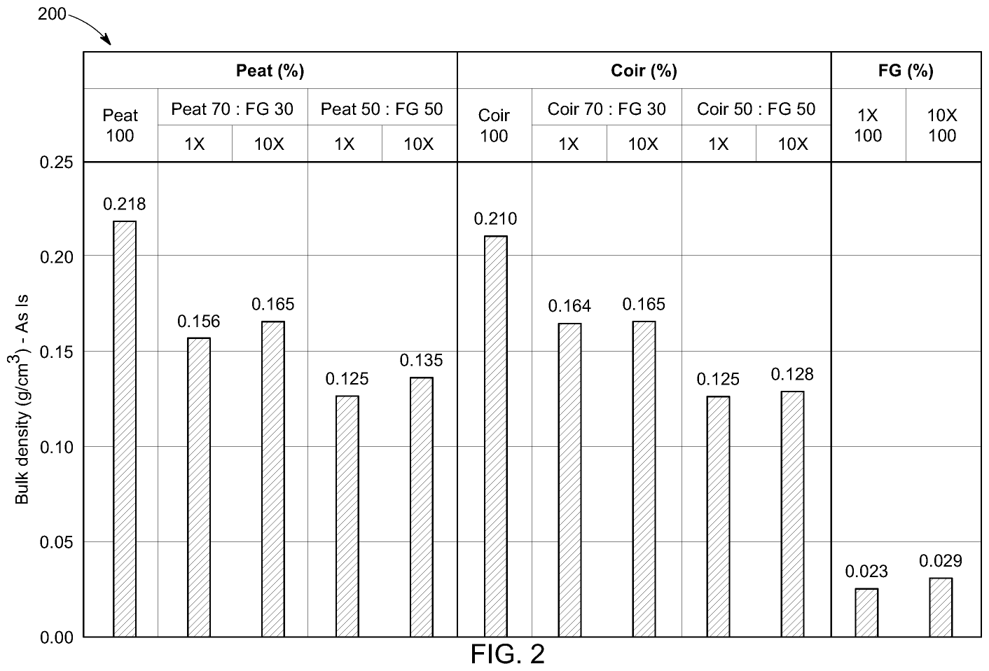

The results of the “wet bulk density” trial are shown in the Table 200 of FIG. 2. The 100% peat sample was measured to have a wet bulk density of approximately 0.218 g/cm³. Conversely, replacing a portion of the peat with fiberglass was shown to lower the wet bulk density. In particular, both the 70% peat with 30% fiberglass blends (0.156 g/cm³; 0.165 g/cm³) and the 50% peat with 50% fiberglass blends (0.125 g/cm³; 0.135 g/cm³) exhibited lower wet bulk densities.

The 100% coir sample was measured to have a wet bulk density of approximately 0.210 g/cm³. Similarly, replacing a portion of the coir with fiberglass was shown to lower the wet bulk density. In particular, both the 70% coir with 30% fiberglass blends (0.164 g/cm³; 0.165 g/cm³) and the 50% coir with 50% fiberglass blends (0.125 g/cm³; 0.128 g/cm³) exhibited lower wet bulk densities.

The use of the fiberglass was shown to be an effective component at lowering the wet bulk density (encompassing the more likely state of the natural component of the substrate blend) and, thus, the wet weight of the growth substrate. This is likely because the bulk density of both the coarser nodules FG-1X (0.023 g/cm³) and the finer nodules FG-10X (0.029 g/cm³) is much lower than the bulk density of the peat (0.218 g/cm³) and the coir (0.210 g/cm³). For example, the 70:30 peat and fiberglass blends (samples 2 and 4) were approximately 26% lighter than just peat (sample 1); the 50:50 peat and fiberglass blends (samples 3 and 5) were approximately 40% lighter than just peat (sample 1); the 70:30 coir and fiberglass blends (samples 7 and 9) were approximately 22% lighter than just coir (sample 6); and the 50:50 coir and fiberglass blends (samples 8 and 10) were approximately 40% lighter than just coir (sample 6).

When growing a plant in a container, the amount of water, air, and nutrients available for plant use after irrigation is directly related to the volume of these resources retained by the growth substrate. A higher bulk density of the growth substrate typically results in a lower porosity and a decreased air space, which can impair plant growth by limiting distribution and retention of these resources. As shown above, replacing a portion of the natural, hygroscopic component of a potting mix with glass fibers, such as a conditioned ULF material, allows for the design of growth substrates with lower bulk densities and weights.

In a growth substrate, pores are the spaces between the solid components of the substrate. Pore size determines the rate of drainage and gas exchange. Larger pores (macropores) maintain air spaces and facilitate drainage, while smaller pores (micropores) retain water. There are three recognized stages for describing water holding capacity: saturation, container or field capacity, and wilting or permanent wilting point. At container capacity, gravitational water has drained, and the medium contains available water and unavailable water for plant growth.

Pore space is expressed in terms of porosity, which is the percentage of pore space volume for a given substrate volume. A portion of the pore space of a growth substrate will be water space and a portion will be air space. In particular, for a container filled with the growth substrate (i.e., potting mix), the growth substrate is saturated with water and then allowed to drain, with the water that is left in the substrate constituting the water space (i.e., container capacity). Based on the volume of the water that drained out of the substrate, the air space can be calculated by Equation 3 below.

$$Air space ( \% ) = 100 \times \frac{{V}_{dw}}{{V}_{c}} \qquad Equation ( 3 )$$

where V_{dw} is the volume of the water that drains out of the saturated growth substrate filling the container under the effects of gravity and V_{c}=is the total volume of the substrate.

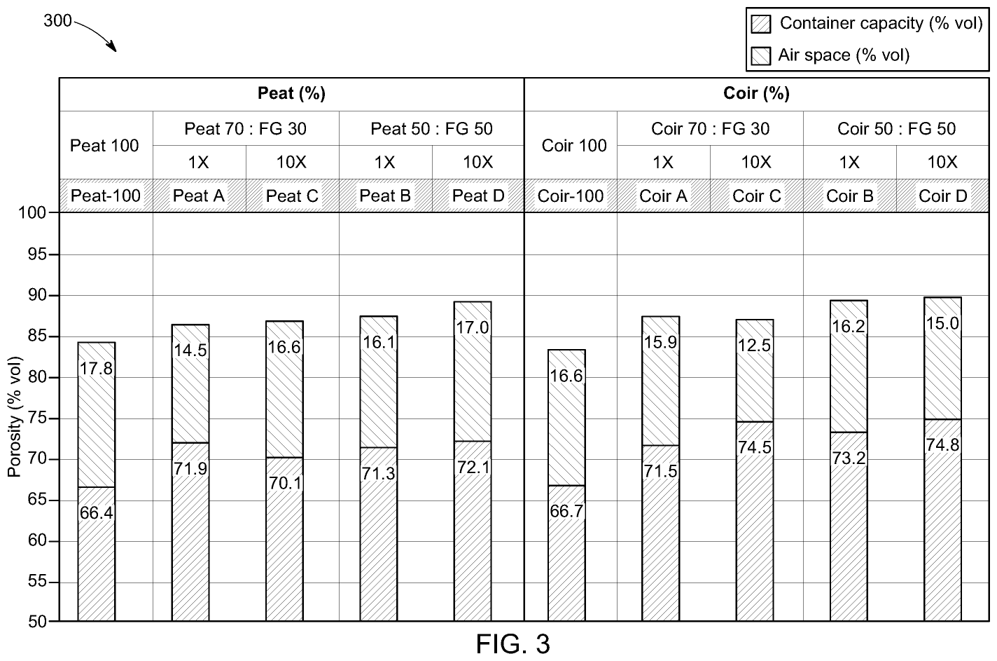

In another trial, the impact of adding fiberglass to a growth substrate on air space and container capacity were assessed. The trial was performed using the method described in the publication entitled Impact of Hydrogel on Physical Properties of Coarse-structured Horticultural Substrates by Fonteno et al. in the Journal of the American Society for Horticultural Science v.118 (2), pp. 217-222 (1993) for a 3 inch tall container. The results of the “porosity” trial are shown in the Table 300 of FIG. 3.

As shown in the table 300, the 100% peat sample was measured to have a porosity of approximately 84.2%, based on the volume of the growth substrate, which corresponds to a container capacity of approximately 66.4% and an air space of approximately 17.8%.

More specifically, the 70% peat and 30% FG-1X blend was measured to have a total porosity of approximately 86.4%, based on the volume of the growth substrate, which corresponds to a container capacity of approximately 71.9% and an air space of approximately 14.5%. The 70% peat and 30% FG-10X blend was measured to have a total porosity of approximately 86.7%, based on the volume of the growth substrate, which corresponds to a container capacity of approximately 70.1% and an air space of approximately 16.6%. The 50% peat and 50% FG-1X blend was measured to have a total porosity of approximately 87.4%, based on the volume of the growth substrate, which corresponds to a container capacity of approximately 71.3% and an air space of approximately 16.1%. The 50% peat and 50% FG-10X blend was measured to have a total porosity of approximately 89.1%, based on the volume of the growth substrate, which corresponds to a container capacity of approximately 72.1% and an air space of approximately 17.0%.

In the case of both peat and fiberglass blends (i.e., the 70:30 and the 50:50 blends), the addition of the fiberglass led to an increase in total porosity of the growth substrate. In particular, an increase in the range of 4% to 6% was observed for container capacity, while a decrease in the range of 0% to 3% was observed for air space, with respect to these blends. As a result, an increase in the range of 2% to 5% was observed for total porosity, with respect to these blends.

The 100% coir sample was measured to have a porosity of approximately 83.3%, based on the volume of the growth substrate, which corresponds to a container capacity of approximately 66.7% and an air space of approximately 16.6%.

More specifically, the 70% coir and 30% FG-1X blend was measured to have a total porosity of approximately 87.4%, based on the volume of the growth substrate, which corresponds to a container capacity of approximately 71.5% and an air space of approximately 15.9%. The 70% coir and 30% FG-10X blend was measured to have a total porosity of approximately 87.0%, based on the volume of the growth substrate, which corresponds to a container capacity of approximately 74.5% and an air space of approximately 12.5%. The 50% coir and 50% FG-1X blend was measured to have a total porosity of approximately 89.4%, based on the volume of the growth substrate, which corresponds to a container capacity of approximately 73.2% and an air space of approximately 16.2%. The 50% coir and 50% FG-10X blend was measured to have a total porosity of approximately 89.8%, based on the volume of the growth substrate, which corresponds to a container capacity of approximately 74.8% and an air space of approximately 15.0%.

In the case of both coir and fiberglass blends (i.e., the 70:30 and the 50:50 blends), the addition of the fiberglass led to an increase in total porosity of the growth substrate. In particular, an increase in the range of 5% to 8% was observed for container capacity, while a decrease in the range of 0% to 4% was observed for air space, with respect to these blends. As a result, an increase in the range of 4% to 7% was observed for total porosity, with respect to these blends.

The conditioning (e.g., altering of nodule size) of the fiberglass material did not appear to have a consistent impact on the total porosity across all of the blends. Nonetheless, as shown in the table 300, replacement of a significant portion of the pure peat or coir (e.g., suitable for use in a growth substrate) was accomplished with comparable, if not increased, porosity being achieved.

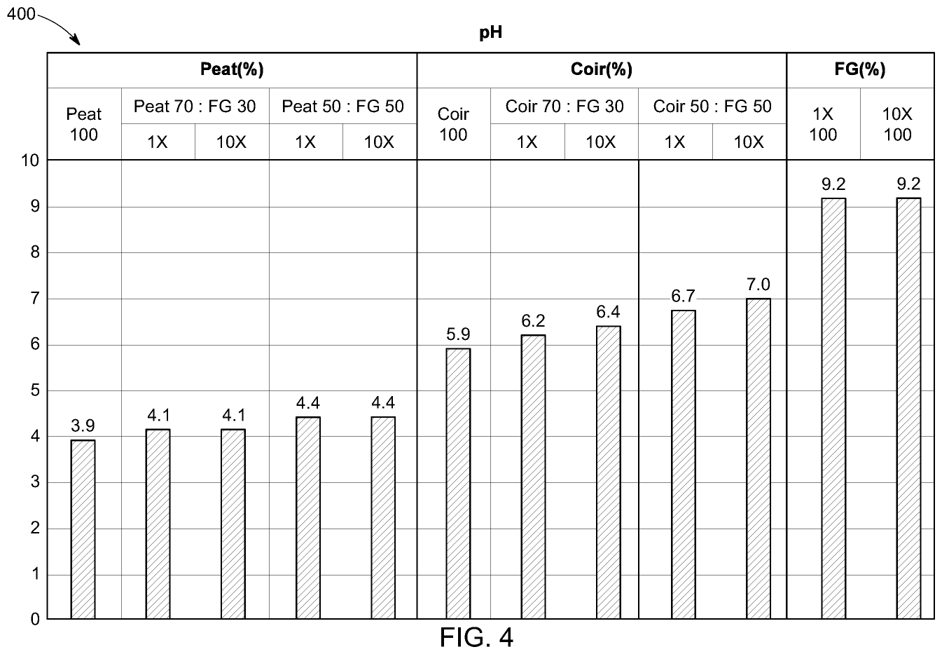

In another trial, the impact of adding fiberglass to a growth substrate on pH was assessed. The results of the “pH” trial are shown in the Table 400 of FIG. 4.

The 100% peat sample exhibited a pH of approximately 3.9, while the 70% peat with 30% FG-1X blend was measured to have a pH of approximately 4.1, the 70% peat with 30% FG-10X blend was measured to have a pH of approximately 4.1, the 50% peat with 50% FG-1X blend was measured to have a pH of approximately 4.4, and the 50% peat with 50% FG-10X blend was measured to have a pH of approximately 4.4.

The 100% coir sample exhibited a pH of approximately 5.9, while the 70% coir with 30% FG-1X blend was measured to have a pH of approximately 6.2, the 70% coir with 30% FG-10X blend was measured to have a pH of approximately 6.4, the 50% coir with 50% FG-1X blend was measured to have a pH of approximately 6.7, and the 50% coir with 50% FG-10X blend was measured to have a pH of approximately 7.0.

In view of the above, it was shown that although the pure glass fibers create an alkaline condition, with a pH of approximately 9.2 in the case of both the FG-1X and the FG-10X fibers, the actual impact of replacing a significant portion of the peat or coir in the growth substrate with the glass fibers was relatively small due to the low amount of the fiberglass mass in the blends.

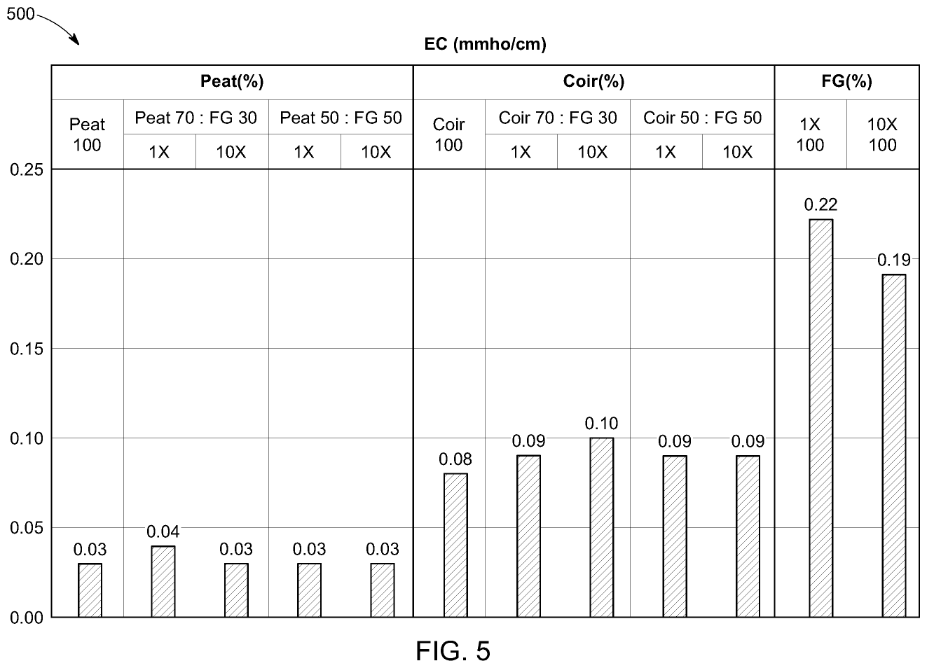

In another trial, the impact of adding fiberglass to a growth substrate on electrical conductivity (EC) in mmho/cm (with 1 mmho/cm equal to 1 mS/cm) was assessed. The results of the “EC” trial are shown in the Table 500 of FIG. 5.

The 100% peat sample exhibited an EC of approximately 0.03, while the 70% peat with 30% FG-1X blend was measured to have an EC of approximately 0.04, the 70% peat with 30% FG-10X blend was measured to have an EC of approximately 0.03, the 50% peat with 50% FG-1X blend was measured to have an EC of approximately 0.03, and the 50% peat with 50% FG-10X blend was measured to have an EC of approximately 0.03.

The 100% coir sample exhibited an EC of approximately 0.08, while the 70% coir with 30% FG-1X blend was measured to have an EC of approximately 0.09, the 70% coir with 30% FG-10X blend was measured to have an EC of approximately 0.10, the 50% coir with 50% FG-1X blend was measured to have an EC of approximately 0.09, and the 50% coir with 50% FG-10X blend was measured to have an EC of approximately 0.09.

In view of the above, it was shown that although the pure glass fibers have an EC of approximately 0.22 in the case of the FG-1X fibers and an EC of approximately 0.19 in the case of the FG-10X fibers, the actual impact on EC of replacing a significant portion of the peat or coir in the growth substrate with the glass fibers was relatively small due to the low amount of the fiberglass mass in the blends.

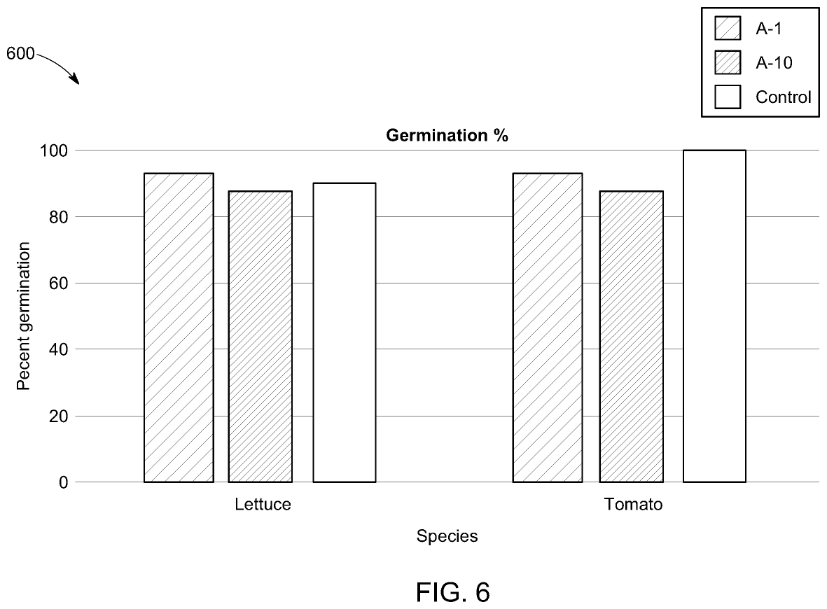

In another trial, the phytotoxicity of fiberglass as a growth substrate component was assessed. The results of the “phytotoxicity” trial are shown in the Table 600 of FIG. 6.

In this trial, 3 samples were compared. The first sample (A-1) was prepared by soaking 100% of the FG-1X material described above in a water solution for 12 hours and then extracting the leachate. The second sample (A-10) was prepared by soaking 100% of the FG-10X material described above in a water solution for 12 hours and then extracting the leachate. The third sample (control) was tap water.

The A-1 leachate was applied to filter paper in a petri dish containing lettuce seeds, with 4 different petri dishes each with 10 lettuce seeds receiving the A-1 leachate. The A-1 leachate was applied to filter paper in a petri dish with tomato seeds, with 4 different petri dishes each with 10 tomato seeds receiving the A-1 leachate. The A-10 leachate was applied to filter paper in a petri dish containing lettuce seeds, with 4 different petri dishes each with 10 lettuce seeds receiving the A-1 leachate. The A-10 leachate was applied to filter paper in a petri dish with tomato seeds, with 4 different petri dishes each with 10 tomato seeds receiving the A-1 leachate. The tap water control was applied to filter paper in a petri dish containing lettuce seeds, with 4 different petri dishes each with 10 lettuce seeds receiving the tap water control. The tap water control was applied to filter paper in a petri dish containing tomato seeds, with 4 different petri dishes each with 10 tomato seeds receiving the tap water control.

After 4-5 days, the germination of the seeds in each petri dish was assessed, with the averaged results being shown in the Table 600. Because no significant difference in the germination of the lettuce or tomato seeds was observed when the fiberglass containing leachate was applied to the seeds versus when the tap water control was applied to the seeds, it was concluded that the fiberglass material did not exhibit a phytotoxic effect on plant growth.

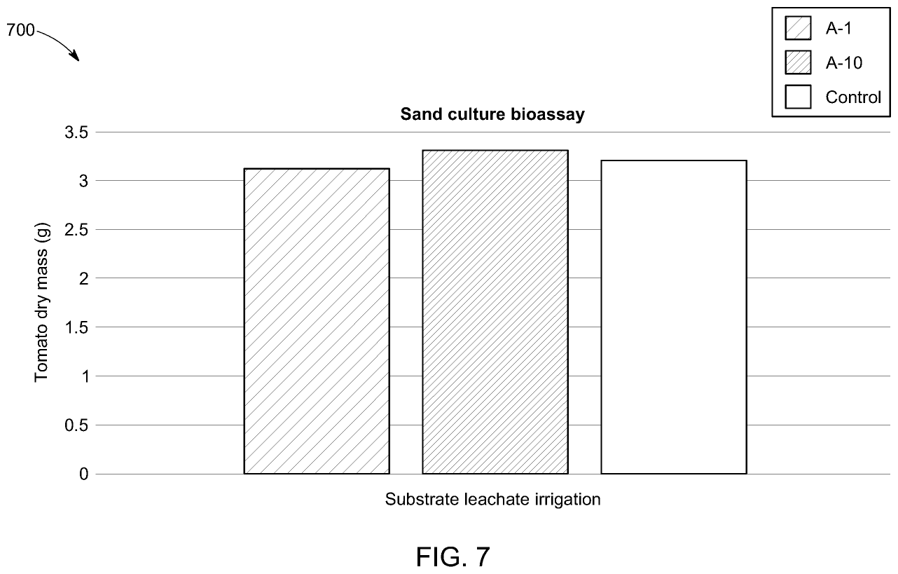

In another trial, the phytotoxicity of fiberglass as a growth substrate component was again assessed. The results of the “phytotoxicity” trial are shown in the Table 700 of FIG. 7.

In this trial, 3 samples were compared. The first sample (A-1) was prepared by soaking 100% of the FG-1X material described herein in a water solution for 12 hours and then extracting the leachate. The second sample (A-10) was prepared by soaking 100% of the FG-10X material described herein in a water solution for 12 hours and then extracting the leachate. The third sample (control) was tap water. For each of the samples, fertilizer was added to the sample and the sample was stored in a cooler.

Each of the samples was used to water a distinct tomato plant being grown in a sand culture, with each plant being at essentially the same growth stage immediately prior to the trial commencing. Each of the plants was irrigated with its corresponding sample daily (by hand) for 12 days. At the end of the 12 days, the dry mass in grams of each plant was measured, with the results being shown in the Table 700.

Because no significant difference in the dry mass of the tomato plants was observed when the plants were irrigated with the fiberglass containing leachate versus the tap water control, it was concluded that the fiberglass material did not exhibit a phytotoxic effect on plant growth.

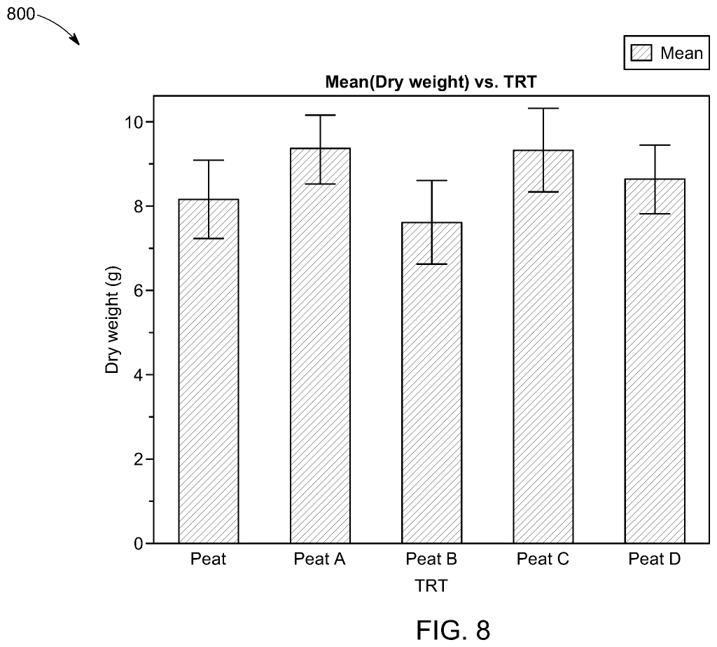

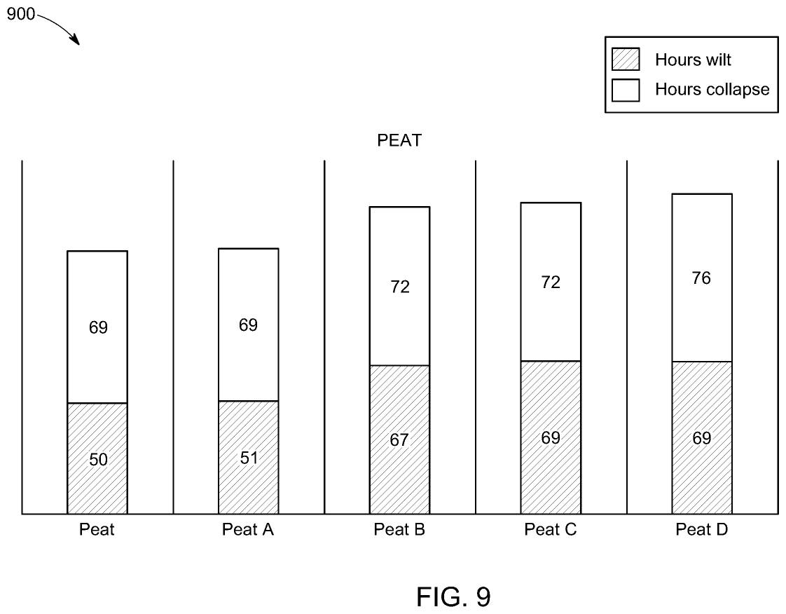

In another trial, the impact on plant growth of fiberglass as a growth substrate component was assessed. The results of the “peat, plant growth” trial are shown in the Table 800 of FIG. 8. In the Table 800, “TRT” refers to treatment and generally describes the peat-based growth substrates being assessed.

In this trial, 5 samples were compared. The first sample (Peat) comprised 100% peat as the growth substrate; the second sample (Peat A) comprised 70% peat and 30% of the FG-1X material described herein; the third sample (Peat B) comprised 50% peat and 50% of the FG-1X material described herein; the fourth sample (Peat C) comprised 70% peat and 30% of the FG-10X material described herein; and the fifth sample (Peat D) comprised 50% peat and 50% of the FG-10X material described herein. In this case the Peat sample could be considered the control, as it represents the conventional use of only natural peat without any glass fibers mixed therein.

Tomato plants were grown from seedlings in each of the sample growth substrates over a period of 4 weeks. During this time, the growing plants were fertigated at 150 ppm (i.e., the fertilizer concentration (by mass) in the irrigation water). The plants were hand irrigated daily upon reaching the state of being greater than 25% below container capacity.

At the end of the 4 weeks, the dry weight in grams of each plant was measured, with the results being shown in the Table 800.

Because no statistical difference in the dry weight of the tomato plants was observed when the plants were grown in the fiberglass containing peat substrates versus the pure peat substrate, it was concluded that the fiberglass material did not inhibit the growth of the plant when it replaced a significant portion of the peat. This conclusion was also supported by the fact that comparable perimeter root development was observed across the 5 peat-based samples (i.e., Peat, Peat A, Peat B, Peat C, and Peat D).

In another trial, the impact on time to wilt when fiberglass is used as a growth substrate component to replace a portion of peat was assessed. The results of the “peat, water stress” trial are shown in the Table 900 of FIG. 9.

At the conclusion of the peat-based tomato plant growth trial described in the preceding paragraphs, the plants corresponding to the 5 peat-based samples (i.e., Peat, Peat A, Peat B, Peat C, and Peat D) were fully wetted (i.e., saturated). Thereafter, lysimeters were used to continuously capture weight loss for each of the plants over time. Two key observations were captured: (1) when the plant began to wilt (flagging) and (2) when the leaves of the plant were collapsed against its stem (permanent wilting). The time until each of these observations was encountered for each sample is shown in the Table 900. As can be seen, some of the peat-fiberglass blends (i.e., Peat A, Peat B, and Peat C) were able to substantially extend (e.g., by 17-19 hours) the time to wilt as compared to the pure peat (i.e., Peat) sample. This data suggests that both the amount of the fiberglass introduced into the peat-based blend and the properties of the fiberglass (e.g., its conditioning) are important for extending or otherwise managing water stress during plant growth.

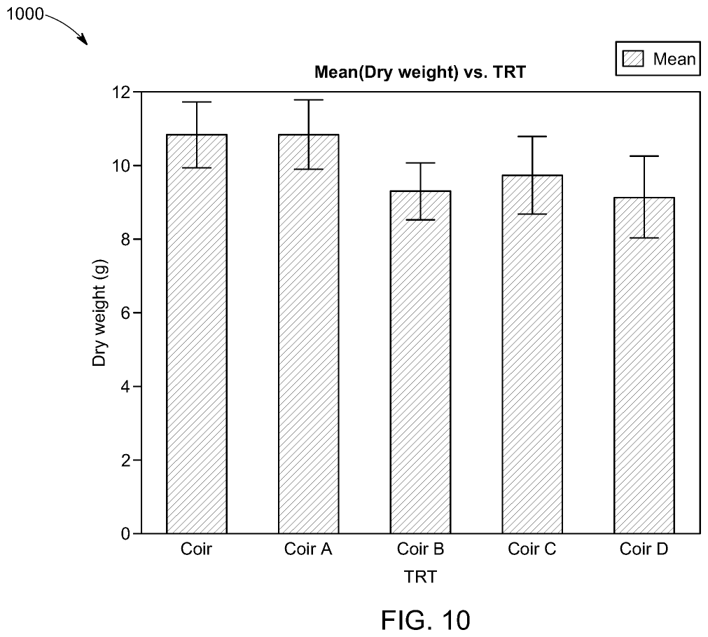

In another trial, the impact on plant growth of fiberglass as a growth substrate component was again assessed. The results of the “coir, plant growth” trial are shown in the Table 1000 of FIG. 10. In the Table 1000, “TRT” refers to treatment and generally describes the coir-based growth substrates being assessed.

In this trial, 5 samples were compared. The first sample (Coir) comprised 100% coir as the growth substrate; the second sample (Coir A) comprised 70% coir and 30% of the FG-1X material described herein; the third sample (Coir B) comprised 50% coir and 50% of the FG-1X material described herein; the fourth sample (Coir C) comprised 70% coir and 30% of the FG-10X material described herein; and the fifth sample (Coir D) comprised 50% coir and 50% of the FG-10X material described herein. In this case the Coir sample could be considered the control, as it represents the conventional use of only natural (albeit processed) coir without any glass fibers mixed therein.

Tomato plants were grown from seedlings in each of the sample growth substrates over a period of 4 weeks. During this time, the growing plants were fertigated at 150 ppm (i.e., the fertilizer concentration (by mass) in the irrigation water). The plants were hand irrigated daily upon reaching the state of being greater than 25% below container capacity.

At the end of the 4 weeks, the dry weight in grams of each plant was measured, with the results being shown in the Table 1000.

Because no statistical difference in the dry weight of the tomato plants was observed when the plants were grown in the fiberglass containing coir substrates versus the pure coir substrate, it was concluded that the fiberglass material did not inhibit the growth of the plant when it replaced a significant portion of the coir. This conclusion was also supported by the fact that comparable perimeter root development was observed across the 5 coir-based samples (i.e., Coir, Coir A, Coir B, Coir C, and Coir D).

In other plant growth trials, improved plant growth (1.7× to 2.2×) was observed when comparing the inventive (i.e., fiberglass containing) growth media to control media (i.e., peat and coir), for the same plant under the same growing conditions.

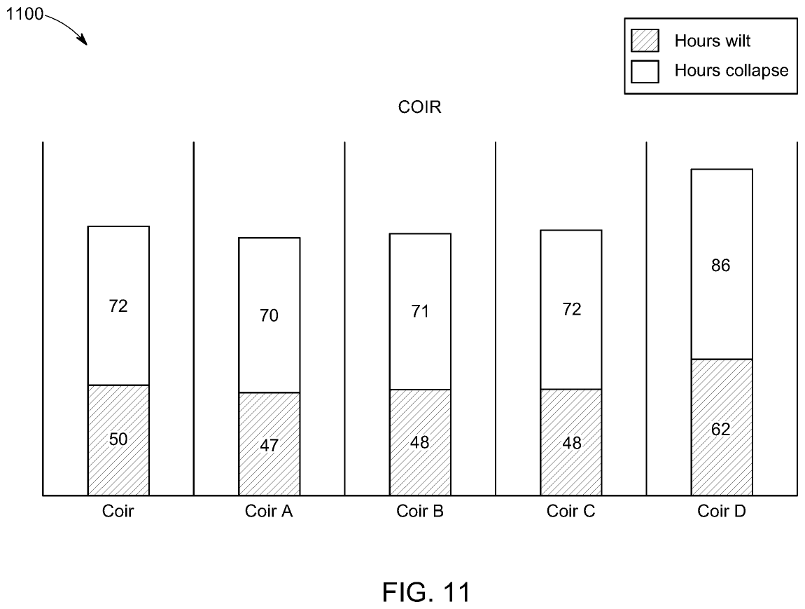

In another trial, the impact on time to wilt when fiberglass is used as a growth substrate component to replace a portion of coir was assessed. The results of the “coir, water stress” trial are shown in the Table 1100 of FIG. 11.

At the conclusion of the coir-based tomato plant growth trial described in the preceding paragraphs, the plants corresponding to the 5 coir-based samples (i.e., Coir, Coir A, Coir B, Coir C, and Coir D) were fully wetted (i.e., saturated). Thereafter, lysimeters were used to continuously capture weight loss for each of the plants over time. Two key observations were captured: (1) when the plant began to wilt (flagging) and (2) when the leaves of the plant were collapsed against its stem (permanent wilting). The time until each of these observations was encountered for each sample is shown in the Table 1100. As can be seen, one of the coir-fiberglass blends (i.e., Coir D) was able to substantially extend (e.g., by about 12 hours) the time to wilt as compared to the pure coir (i.e., Coir) sample. This data suggests that both the amount of the fiberglass introduced into the coir-based blend and the properties of the fiberglass (e.g., its conditioning) are important for extending or otherwise managing water stress during plant growth.

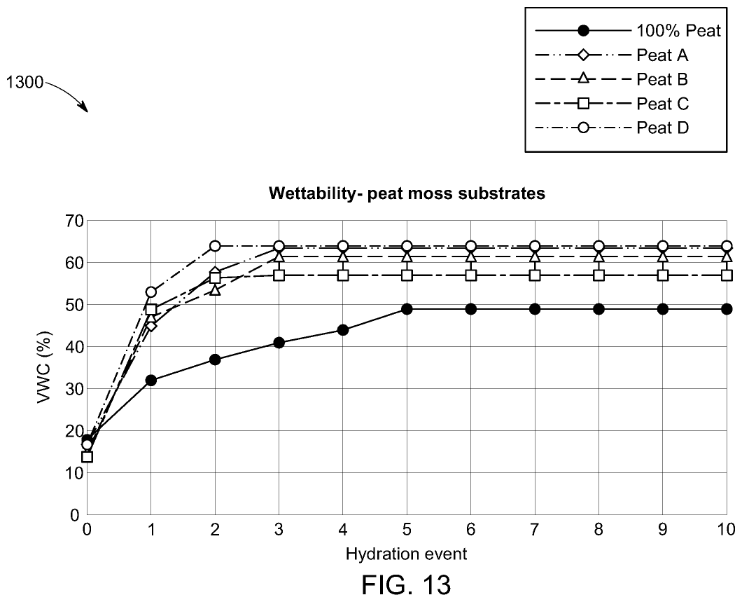

In another trial, the impact on wettability of fiberglass as a growth substrate component in a peat-based blend was assessed. The results of the “peat, top hydration” trial are shown in the Graph 1300 of FIG. 13.

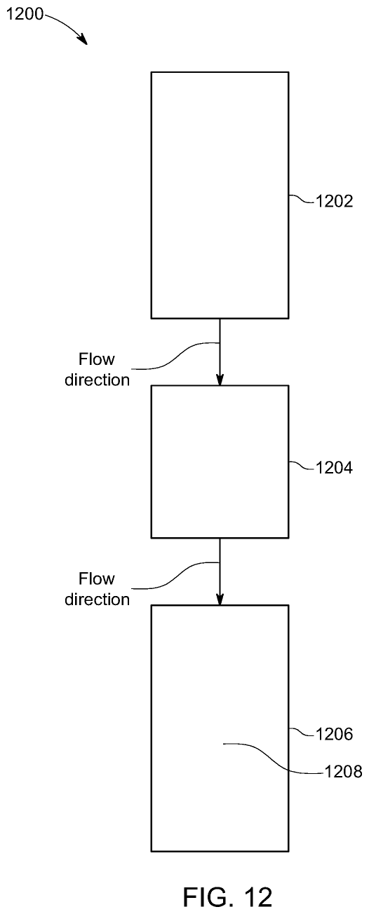

To support this trial, a hydration test device 1200 was constructed, as shown in FIG. 12. The device 1200 includes a water reservoir 1202, a water flow diffuser 1204, and a cylinder 1206 or other container filled with the media 1208 (i.e., the sample being assessed). The device 1200 allows a measured amount of water to flow from the reservoir 1202, through the diffuser 1204, and into the media 1208 in the cylinder 1206. The diffuser 1204 ensures the input water flows into the cylinder 1206 in a controlled manner. Because the bottom of the cylinder 1206 is open, any water not held by the media 1208 in the cylinder 1206 flowed through and out of the cylinder 1206. By measuring the portion of the input water that flowed through and out of the cylinder 1206, the amount of the input water held by the media 1208 was readily determined.

In this trial, 5 samples were compared. The first sample (Peat) comprised 100% peat as the growth substrate; the second sample (Peat A) comprised 70% peat and 30% of the FG-1X material described herein; the third sample (Peat B) comprised 50% peat and 50% of the FG-1X material described herein; the fourth sample (Peat C) comprised 70% peat and 30% of the FG-10X material described herein; and the fifth sample (Peat D) comprised 50% peat and 50% of the FG-10X material described herein. In this case the Peat sample could be considered the control, as it represents the conventional use of only natural peat without any glass fibers mixed therein.

Using the device 1200, water was applied in 10 separate but consecutive hydration events for each sample (i.e., Peat, Peat A, Peat B, Peat C, and Peat D). Each hydration event consisted of 200 mL of water being applied through the device 1200 to the media 1208 contained in the cylinder 1206. The 50 overall measurements are plotted in the Graph 1300, wherein the portion of the input water held by the media 1208 in the cylinder 1206 (i.e., the volume of water contained or VWC %) is shown on the y-axis.

As shown in the Graph 1300, all of the peat-fiberglass blend samples (i.e., Peat A, Peat B, Peat C, and Peat D) were shown to wet more quickly and more thoroughly than the control sample (i.e., Peat). Moreover, these results are for an initial moisture content of 50%, which is favorable to the peat control due to its natural hydrophobicity. Running the trial with the media at a drier initial condition would likely show even more favorable performance for the peat-fiberglass blends.

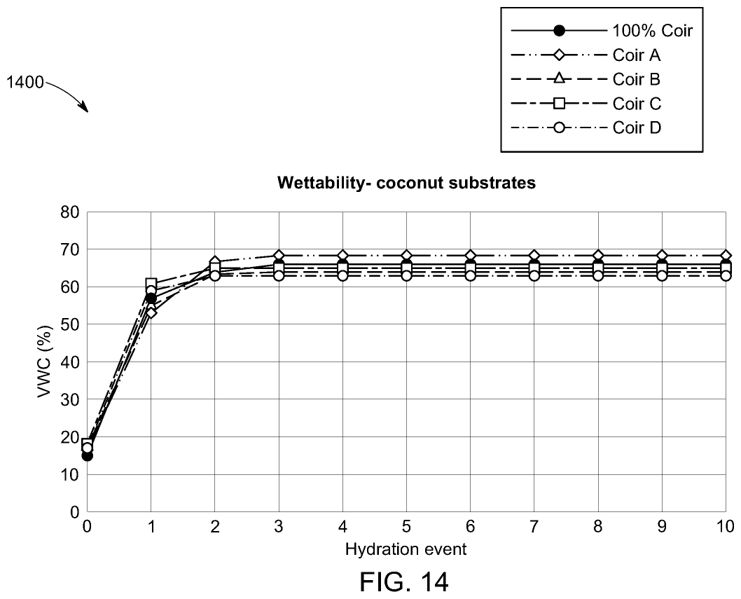

In another trial, the impact on wettability of fiberglass as a growth substrate component in a coir-based blend was assessed. The results of the “coir, top hydration” trial are shown in the Graph 1400 of FIG. 14. This trial used the same hydration test device 1200 (see FIG. 12) as used to generate the results shown in the Graph 1300 of FIG. 13.

In this trial, 5 samples were compared. The first sample (Coir) comprised 100% coir as the growth substrate; the second sample (Coir A) comprised 70% coir and 30% of the FG-1X material described herein; the third sample (Coir B) comprised 50% coir and 50% of the FG-1X material described herein; the fourth sample (Coir C) comprised 70% coir and 30% of the FG-10X material described herein; and the fifth sample (Coir D) comprised 50% coir and 50% of the FG-10X material described herein. In this case the Coir sample could be considered the control, as it represents the conventional use of only natural coir without any glass fibers mixed therein.

Using the device 1200, water was applied in 10 separate but consecutive hydration events for each sample (i.e., Coir, Coir A, Coir B, Coir C, and Coir D). Each hydration event consisted of 200 mL of water being applied through the device 1200 to the media 1208 contained in the cylinder 1206. The 50 overall measurements are plotted in the Graph 1400, wherein the portion of the input water held by the media 1208 in the cylinder 1206 (i.e., the volume of water contained or VWC %) is shown on the y-axis.

As shown in the Graph 1400, all of the coir-fiberglass blend samples (i.e., Coir A, Coir B, Coir C, and Coir D) were shown to perform comparably (N=1) to the control sample (i.e., Coir). Final saturation levels (2≤N≤10) were generally equivalent across all samples. Moreover, these results are for an initial moisture content of 50%, which is favorable to the coir control due to its natural hydrophobicity. Running the trial with the media at a drier initial condition would likely show even more favorable performance for the coir-fiberglass blends.

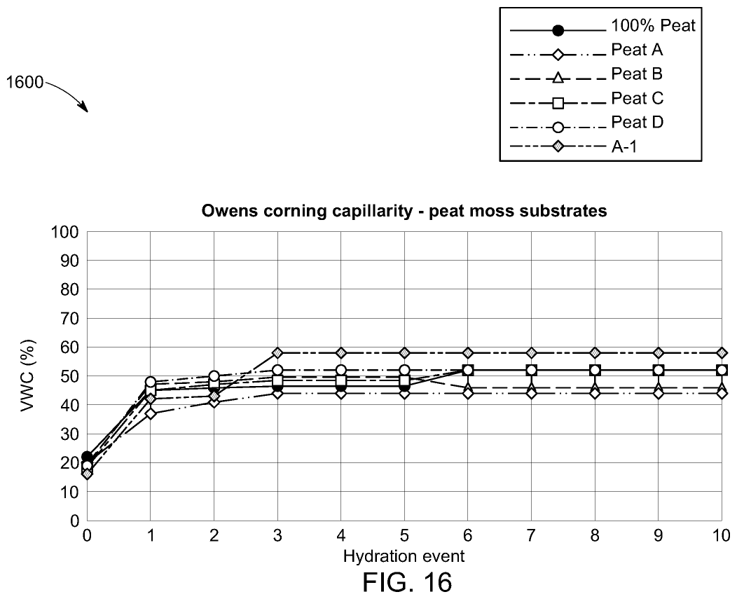

In another trial, the impact on wettability of fiberglass as a growth substrate component in a peat-based blend was assessed. The results of the “peat, bottom hydration” trial are shown in the Graph 1600 of FIG. 16.

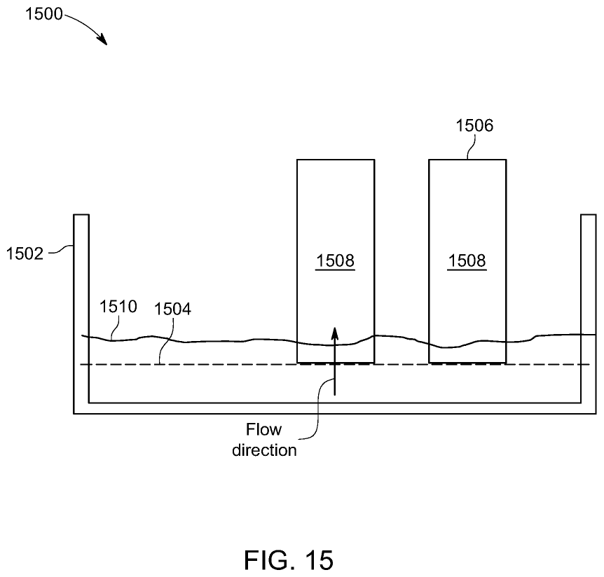

To support this trial, a hydration test device 1500 was constructed, as shown in FIG. 15. The device 1500 includes a water reservoir 1502 (e.g., in the form of a tray). A screen 1504 is situated above a bottom surface of the tray 1502. The screen 1504 supports one or more cylinders 1506, with each cylinder 1506 filled with the media 1508 (i.e., the sample being assessed). In this manner, the tray 1502 is filled with a quantity of water (e.g., to a predetermined water level 1510) that extends above the screen 1504 and above the bottom of each cylinder 1506. Because the bottom of the cylinder 1506 is open, water from the tray 1502 can be drawn up through the screen 1504 and into the cylinder 1506 via capillary action. By measuring the volume of the media 1508 (including moisture) in the cylinder 1506 before and after introduction of the input water, the amount of the input water held by the media 1508 was readily determined.

In this trial, 6 samples were compared. The first sample (Peat A) comprised 70% peat and 30% of the FG-1X material described herein; the second sample (Peat B) comprised 50% peat and 50% of the FG-1X material described herein; the third sample (Peat C) comprised 70% peat and 30% of the FG-10X material described herein; the fourth sample (Peat D) comprised 50% peat and 50% of the FG-10X material described herein.; the fifth sample (A-1) comprised 100% of the FG-1X material; and the sixth sample (Peat) comprised 100% peat as the growth substrate. In this case the Peat sample could be considered the control, as it represents the conventional use of only natural peat without any glass fibers mixed therein.

Using the device 1500, water was applied in 10 separate but consecutive hydration events for each sample (i.e., Peat A, Peat B, Peat C, Peat D, A-1, and Peat). Each hydration event consisted of flooding the sample (in its respective cylinder 1506) from below at a 2.5 cm elevation for 5 minutes. The 60 overall measurements are plotted in the Graph 1600, wherein the portion of the input water held by the media 1508 in the cylinder 1506 (i.e., the volume of water contained or VWC %) is shown on the y-axis.

As shown in the Graph 1600, all of the peat-fiberglass blend samples (i.e., Peat A, Peat B, Peat C, and Peat D) were shown to wet comparably to the control sample (i.e., Peat). Moreover, these results are for an initial moisture content of 50%, which is favorable to the peat control due to its natural hydrophobicity. Running the trial with the media at a drier initial condition would likely show even more favorable performance for the peat-fiberglass blends.

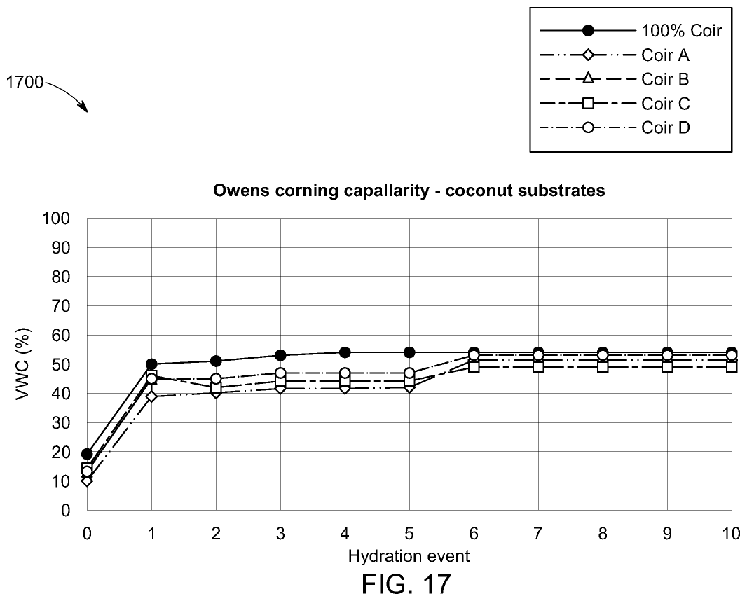

In another trial, the impact on wettability of fiberglass as a growth substrate component in a coir-based blend was assessed. The results of the “coir, bottom hydration” trial are shown in the Graph 1700 of FIG. 17. This trial used the same hydration test device 1500 (see FIG. 15) as used to generate the results shown in the Graph 1600 of FIG. 16.

In this trial, 5 samples were compared. The first sample (Coir A) comprised 70% coir and 30% of the FG-1X material described herein; the second sample (Coir B) comprised 50% coir and 50% of the FG-1X material described herein; the third sample (Coir C) comprised 70% coir and 30% of the FG-10X material described herein; the fourth sample (Coir D) comprised 50% coir and 50% of the FG-10X material described herein; and the fifth sample (Coir) comprised 100% coir as the growth substrate. In this case the Coir sample could be considered the control, as it represents the conventional use of only natural coir without any glass fibers mixed therein.

Using the device 1500, water was applied in 10 separate but consecutive hydration events for each sample (i.e., Coir A, Coir B, Coir C, Coir D, and Coir). Each hydration event consisted of flooding the sample (in its respective cylinder 1506) from below at a 2.5 cm elevation for 5 minutes. The 50 overall measurements are plotted in the Graph 1700, wherein the portion of the input water held by the media 1508 in the cylinder 1506 (i.e., the volume of water contained or VWC %) is shown on the y-axis.

As shown in the Graph 1700, all of the coir-fiberglass blend samples (i.e., Coir A, Coir B, Coir C, and Coir D) were shown to eventually wet comparably to the control sample (i.e., Coir). Moreover, these results are for an initial moisture content of 50%, which is favorable to the coir control due to its natural hydrophobicity. Running the trial with the media at a drier initial condition would likely show even more favorable performance for the coir-fiberglass blends.

While natural materials, such as peat, coir, and wood fiber, have proven an effective component in growth substrates (e.g., potting mixes), they suffer from drawbacks that give rise to an unmet need for substitute materials that are at least as effective as these conventional materials. It has been proven that glass fibers can effectively replace a portion of these natural bulking materials in potting mixes. The glass fibers avoid many of the drawbacks associated with the natural materials (e.g., sustainability, required pre-processing, nitrogen immobilization, decay, etc.).

In some exemplary embodiments, the fiberglass material (e.g., the ULF nodules) encompassed by the general inventive concepts will comprise glass fibers formed from a composition including about 20 wt. % to about 75 wt. % of SiO₂; about 1 wt. % to about 30 wt. % of Al₂O₃; and about 1 wt. % to about 25 wt. % of Na₂O.

Furthermore, as a man-made material, the glass fibers have properties that can be readily tuned or otherwise controlled to fashion new and/or improved potting mixes. Furthermore, the properties of the glass fibers can be more consistent and/or predictable than those of the natural materials. Several exemplary (i.e., non-limiting examples) of various techniques and/or resulting advantages that can be achieved by using glass fibers as a component in soilless growth substrates, such as potting mixes, will be provided for illustration purposes.

### Porosity Manipulation

A network or collection of glass fibers can form openings (i.e., pores) therethrough. These pores contribute to the porosity of the material, which is important for plant growth as the pores can be designed to improve their water holding ability and/or their air delivering ability.

For example, in the case of water holding ability, gravitational pressure (P_{g}) tends to pull the water down through the growth substrate in accordance with Equation 4.

$${P}_{g} = ρ g h \qquad Equation ( 4 )$$

where ρ is the water density, g is gravity, and h is the height of the pot/container.

However, by manipulating the pore radius within the growth substrate, the gravitational pull on the water can be counteracted by creating a capillary pressure (P_{c}) in accordance with Equation 5. This capillary pressure increases the growth substrate's ability to hold the water.

$${P}_{c} = \frac{2 γcosθ}{r} \qquad Equation ( 5 )$$

where γ is the surface tension, θ is the wetting angle, and r is the pore radius.

With glass fibers, the pore radius can be reduced with lower fiber diameter, higher density, or a combination thereof. Likewise, the pore radius can be increased with higher fiber diameter, lower density, or a combination thereof.

In some exemplary embodiments, the density of the fibers is maintained by mechanical entanglement of the fibers. In some exemplary embodiments, the density of the fibers is maintained by a binding agent.

Thus, the ability to manipulate porosity when using glass fibers in a potting mix can provide many advantages. For example, creating smaller pore sizes to achieve higher capillary pressure could provide improved water retention in taller pots (e.g., shrubs, bushes); improve water retention at different portions/layers of the growth substrate to enable controlled substrate stratification, provide for delayed water release to plant roots (i.e., customized dry-down of the growing media).

### Hydrophobic/Hydrophilic Behavior

Glass fibers are naturally hydrophilic. However, glass fibers can be made hydrophobic, for example, by application of one or more of the following ingredients: silicone emulsion, methyl hydrogen fluid (MHF), and amino silanes. These ingredients can be applied to the glass fibers during production or downstream thereof.

It is also possible to achieve varying degrees of hydrophobicity, for example, by adjusting the application amount (affects all of the fibers) or by applying the treatment to a portion of the fibers and leaving the remaining fibers untreated. Thus, the hydrophobic/hydrophilic behavior of the glass fibers can be delivered in a unimodal (all of the fibers have the same level of hydrophobicity) or bimodal manner (some of the fibers are hydrophobic with the rest being hydrophilic).

As described herein, both water retention and aeration are important aspects of a growing media. Because the use of glass fibers allows for customized hydrophobic/hydrophilic behavior, plant growth can be optimized or otherwise improved by balancing water retention and aeration characteristics.

Manipulating Nodule Size and/or Shape

Fiberglass materials can be made in many different sizes (e.g., fiber diameter, fiber length) and shapes. For example, unbonded loosefill (ULF) is one type of fiberglass material made by a rotary fiber forming process followed by milling or the like to form nodules/tufts, such as described in U.S. Pat. No. 10,876,286, the entire disclosure of which is incorporated herein by reference. This process allows for the size of the nodules to be readily controlled. In the diagram 1800 of FIG. 18, two different nodule sizes A, B are shown.

The effectiveness of a growing media is dependent upon particle morphology and arrangement, as these properties are responsible for pore space organization and distribution. Consequently, the size of the ULF nodule will affect how readily the growing media absorbs or releases water as a result of the nodule's outer surface area interfacing with the other components of the growing media.

For a fixed volume of nodules, smaller nodules create more exposed surface area than larger nodules. The shape of the nodule (e.g., plate-like, spherical, cylindrical, etc.) similarly has an effect on the outer surface area that interfaces with the other growing media (e.g., a sphere has the minimum outer surface area for a given volume).

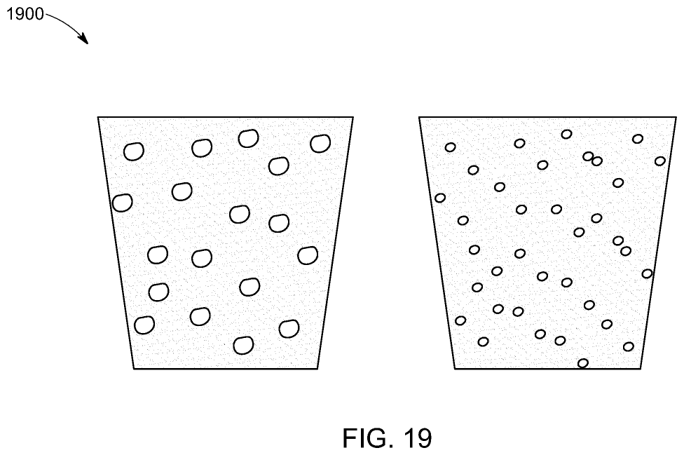

With reference to the diagram 1900 of FIG. 19, both nodules A and nodules B have the same fiberglass volumetric inclusion amount in identical growth substrates. However, the size of the nodules A is twice the size of the nodules B. For spherical-shaped nodules, the smaller nodules B would have eight times the exposed surface area of the larger nodules A, thereby providing a more direct connection to the surrounding base media.

Accordingly, because the size and/or shape of the fiberglass nodules can be adjusted, a growing media including the fiberglass nodules can be tuned to regulate the rate at which the growing media absorbs and releases water. As such, the growing media can be customized to have a desired response to a water stress event (e.g., neglectful watering).

### Multiple Fiber Diameters

As noted above, using glass fibers with a smaller diameter (i.e., finer fibers), such as fibers having a diameter less than 5 μm, is one way to reduce pore size. Finer fibers can also result in reduced irritability from handling. However, finer fibers are structurally weaker than larger diameter (i.e., coarser) fibers, resulting in nodules that can be compressed more easily to the detriment of plant growth and support.

Thus, in some exemplary embodiments, it is proposed to use a combination of finer fibers (e.g., having a diameter less than 5 μm) and coarser fibers (e.g., having a diameter greater than 5 μm) as a component of the growing media. For example, the fiberglass nodules can be constructed from two or more different diameter fibers, with the finer fibers contributing to water holding and the coarser fibers providing compressive resistance to the nodule. In this manner, the fiberglass nodules are less vulnerable to collapsing under load in the growing media. Additionally, a (wt. %) ratio of the finer fibers to the coarser fibers included in the growing media can be varied (e.g., between 1:9 to 9:1) to further control the properties of the growing media.

One exemplary benefit of the tunability of the growing media afforded by the inclusion of the glass fibers is the potential to improve the moisture retention of the growing media.

To illustrate this benefit, a trial comparing an inventive growing media formed with 50% peat and 50% fiberglass (i.e., the FG-1X material) to the same growing media formed only with peat (i.e., the control sample) was conducted. Both samples were evaluated using a method that measures the evaporation rate and tension at multiple depths, as described in the publication entitled Evaporation Method for Measuring Unsaturated Hydraulic Properties of Soils: Extending the Measurement Range by Schindler et al. in the Soil Science Society of America Journal v.74 (4), pp. 1071-1083 (2010).

The resulting moisture retention data (i.e., curves) represent the relationship between the water content and the tension/potential (matric potential) in the growing media. The matric potential is attributed to capillary and adsorptive forces acting between liquid, gaseous, and solid phases. Capillarity results from the surface tension of water and its contact angle with the solid particles.

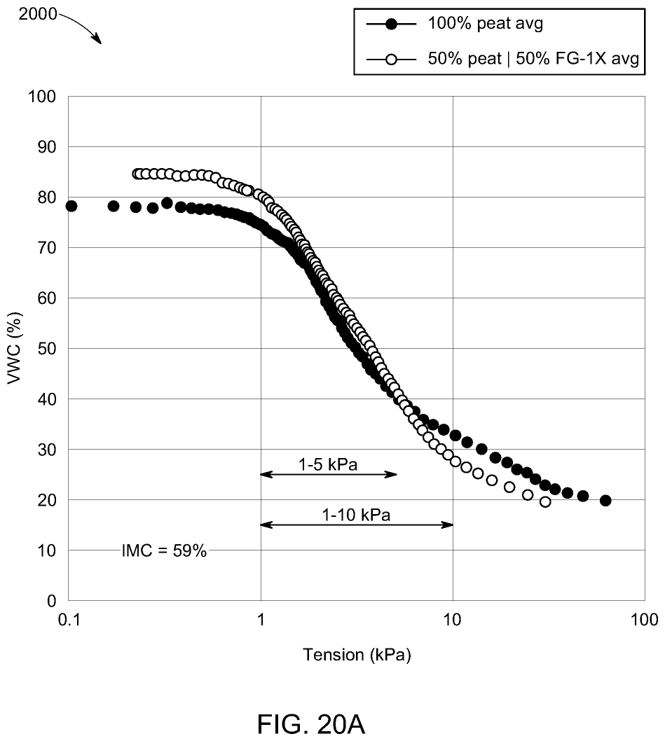

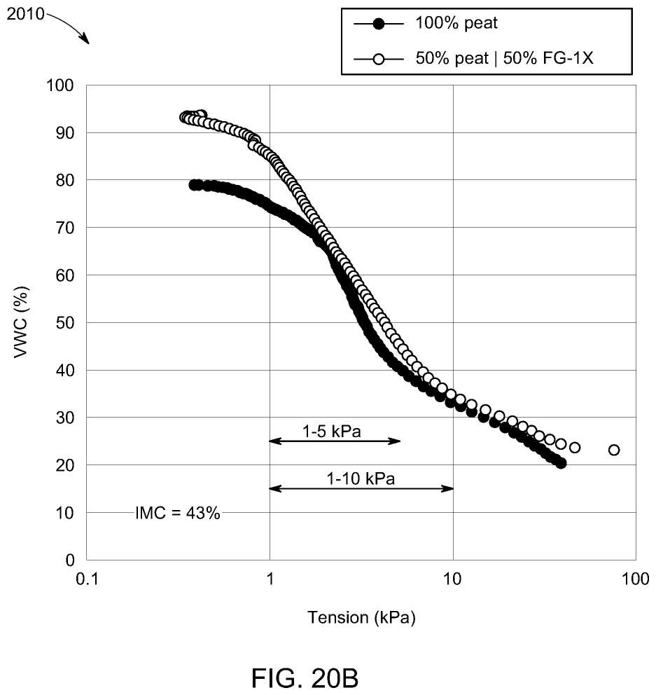

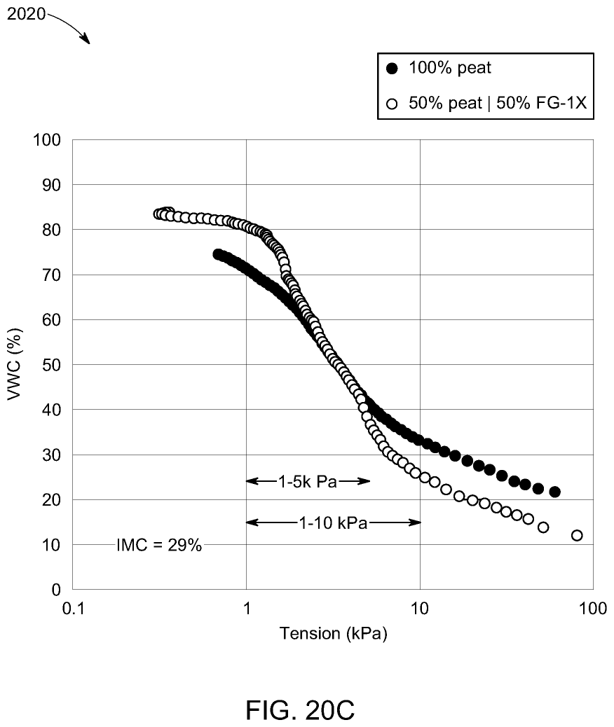

The results of the “evaporation” trial are shown in the Graphs 2000, 2010, and 2020 of FIGS. 20A-20C, respectively. In the Graph 2000 (FIG. 20A), the initial moisture content (IMC) of the peat was approximately 59%; in the graph 2010 (FIG. 20B), the IMC of the peat was approximately 43%; and in the graph 2020 (FIG. 20C), the IMC of the peat was approximately 29%. In the Graphs 2000, 2010, and 2020, the volume of water contained or VWC % in the sample is shown on the y-axis, while the tension (i.e., suction pressure) kPa required to access or otherwise use the water of the sample is shown on the x-axis. In FIG. 20A, each data point on the moisture retention curves for the inventive growing media and the control growing media is the average of four replicate samples. In FIGS. 20B and 20C, each data point on the moisture retention curves for the inventive growing media and the control growing media is for one replicate sample. Important regions of the moisture retention curves are (i) the 1-5 kPa region, wherein larger water-filled pores are able to retain the water in an easily available form (i.e., easily-available water (EAW)) for the plant; (ii) the 1-10 kPa region, wherein smaller water-filled pores cause the water to be more difficult to extract (since held at higher tension) resulting in less water being available (i.e., water-buffering capacity (WBC)); and (iii) the 10+kPa region, wherein extremely small pores retain the water so tightly that the plant cannot extract the water (i.e., unavailable water (UW)).

As described above, since the fiberglass-containing growing media is expected to allow for some control over the pore size, the pore size distribution, and/or other properties of the growing media critical to moisture retention, the inventive growing media was expected to outperform the control growing media. This was the case in the “evaporation” trial, as detailed in Table 2 below. In particular, as shown in Table 2, the inclusion of the fiberglass (i.e., the FG-1X material) in the inventive growing media was shown to increase access to both the EAW and the WBC relative to the control growing media. Inclusion of the fiberglass (i.e., the FG-1X material) in the inventive growing media was also observed to decrease the UW (i.e., at 10+kPa, from 32.3% VWC for the control growing media (IMC=59%) to 27.8% VWC for the inventive growing media).

Furthermore, it is well established that peat becomes more hydrophobic as its initial moisture content decreases (see, e.g., the publication entitled Hydration Efficiency of Traditional and Alternative Greenhouse Substrate Components by Fields et al. in HortScience v.49 (3), pp. 336-342 (2014)). As described above, since the fiberglass-containing growing media is expected to allow for some control over the pore size, the pore size distribution, and/or other properties of the growing media critical to moisture retention, the inventive growing media was expected to outperform the control growing media. This was observed in the “evaporation” trial, as detailed in Table 2 below, showing that the benefits of the inventive growing media compared to the control growing media increase as the initial moisture content of the peat becomes drier.

TABLE 2

| | | |
|---|---|---|
| | | Benefit of |
| 100% Peat | 50% Peat and | Fiberglass |
| (Control) Sample | 50% FG-1X Sample | Inclusion |

Peat IMC = 59%

| | | | |
|---|---|---|---|
| 1-5 kPa: | 33.4 | 38.3 | +15% |
| Volume of Water | | | |
| Released (%) | | | |
| 1-10 kPa: | 41.6 | 52.2 | +25% |
| Volume of Water | | | |
| Released (%) | | | |

Peat IMC = 43%

| | | | |
|---|---|---|---|
| 1-5 kPa: | 33.8 | 39.3 | +16% |
| Volume of Water | | | |
| Released (%) | | | |
| 1-10 kPa: | 41.4 | 50.3 | +21% |
| Volume of Water | | | |
| Released (%) | | | |

Peat IMC = 29%

| | | | |
|---|---|---|---|
| 1-5 kPa: | 29.8 | 42.7 | +43% |
| Volume of Water | | | |
| Released (%) | | | |
| 1-10 kPa: | 38.2 | 55.3 | +45% |
| Volume of Water | | | |
| Released (%) | | | |

Another exemplary benefit of the tunability of the growing media afforded by the inclusion of the glass fibers is the potential to improve the hydraulic conductivity of the growing media.

To illustrate this benefit, a trial comparing an inventive growing media formed with 50% peat and 50% fiberglass (i.e., the FG-1X material) to the same growing media formed only with peat (i.e., the control sample) was conducted. Both samples were evaluated using a method that measures the evaporation rate and tension at multiple depths, as described in the publication entitled Evaporation Method for Measuring Unsaturated Hydraulic Properties of Soils: Extending the Measurement Range by Schindler et al. in the Soil Science Society of America Journal v.74 (4), pp. 1071-1083 (2010).

The resulting hydraulic conductivity data (i.e., curves) represent a measure of how readily water can move through the pore spaces and fractures of a porous material (here, the growing media) when subjected to a pressure difference. The measurement can be performed on unsaturated growing media and saturated growing media. The test method used for the unsaturated media is described in the aforementioned Schindler et al. publication, while the test method used for the saturated media is the falling head method described in ASTM D2434. Assessing hydraulic conductivity of the growing media in an unsaturated state is important to understanding how moisture moves through the media as it dries out and attempts to redistribute its water.

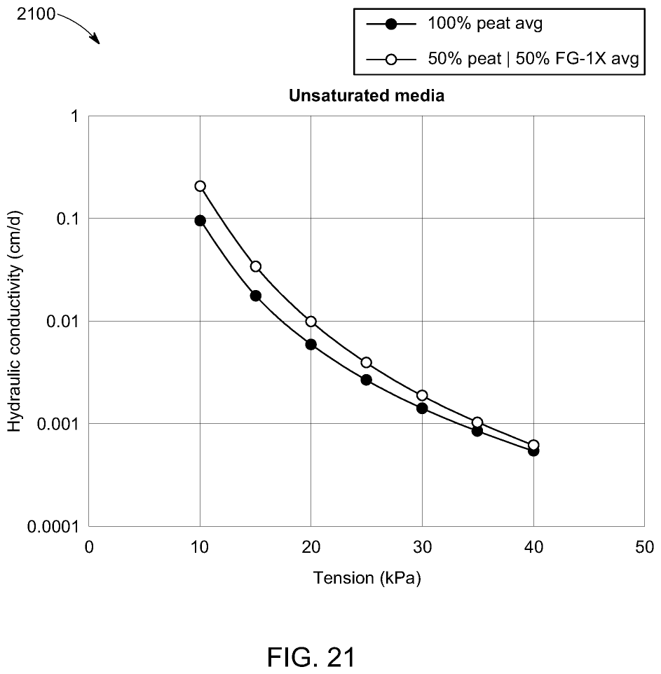

The results of the “hydraulic conductivity” trial for the unsaturated state are shown in the Graph 2100 of FIG. 21. In the Graph 2100, the hydraulic conductivity of the sample growing media is shown on the y-axis, while the tension (i.e., suction pressure) applied to the sample is shown on the x-axis. Here, the hydraulic conductivity represents how much water would flow through the growing media per a given time, which in the Graph 2100 is represented as cm per day (cm/d). Each data point on the hydraulic conductivity curves for the inventive growing media and the control growing media is the average of four replicate samples.

As described above, since the fiberglass-containing growing media is expected to allow for some control over the pore size, the pore size distribution, and/or other properties of the growing media critical to moisture retention, the inventive growing media was expected to outperform the control growing media. This was the case in the “hydraulic conductivity” trial for both the unsaturated and the saturated conditions. In particular, as can be seen in the Graph 2100, the inventive growing media exhibited an increased hydraulic conductivity in the unsaturated state compared to the control growing media, with the improvement ranging from about 13% at 40 kPa to about 120% at 10 kPa. It was also the case that the inventive growing media exhibited an increased hydraulic conductivity in the saturated state compared to the control growing media, with the improvement ranging being about +26%, as shown in Table 3 below.

TABLE 3

| | | | Benefit of |
|---|---|---|---|
| | 100% Peat | 50% Peat and | Fiberglass |
| | (Control) Sample | 50% FG-1X Sample | Inclusion |
| Saturated Media: | 3105 | 3908 | +26% |
| Hydraulic | | | |
| Conductivity | | | |
| (cm/d) | | | |

In view of the above, inventive potting mixes, as well as systems for and methods of using the inventive potting mixes to promote plant growth in a container, are provided. The inventive potting mixes include a quantity of glass fibers therein. The inventive fiberglass-based potting mixes achieve comparable or better results than conventional peat-based or coir-based potting mixes, and do so at a reduced cost, at a reduced volume, and/or while avoiding one or more drawbacks associated with the conventional approaches and materials.

In some embodiments, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. The scope of the general inventive concepts presented herein are not intended to be limited to the particular exemplary embodiments shown and described herein. From the disclosure given, those skilled in the art will not only understand the general inventive concepts and their attendant advantages, but will also find apparent various changes and modifications thereto. For example, notwithstanding the illustrative embodiments disclosing the fiberglass material in the form of nodules, the general inventive concepts contemplate that the fiberglass material can assume any form suitable for use as a component of a growing media (e.g., a potting mix). Thus, the fiberglass material could simply be a quantity of loose fibers (with or without added functional surface chemistry), fibers held together by binding chemistry, a collection of entangled (e.g., needled) fibers, a quantity of texturized glass fibers (often referred to as “glass wool”), a non-woven mat, etc. In some instances, conventional fiberglass products, such as insulation batts, could be processed (e.g., shredded) to form the fiberglass material. It is sought, therefore, to cover all such changes and modifications as fall within the spirit and scope of the general inventive concepts, as described and/or claimed herein, and any equivalents thereof.

What is claimed is:

1. A soilless growing media comprising a blend of a quantity of a natural material and a quantity of a fiberglass material.

2. The soilless growing media of claim 1, wherein a ratio of the natural material to the fiberglass material is in the range of 1:4 to 4:1 by volume.

3. The soilless growing media of claim 1, wherein a ratio of the natural material to the fiberglass material is about 7:3 by volume.

4. The soilless growing media of claim 1, wherein a ratio of the natural material to the fiberglass material is about 1:1 by volume.

5. The soilless growing media of claim 1, wherein the natural material is peat.

6. The soilless growing media of claim 1, wherein the natural material is coconut coir.

7. The soilless growing media of claim 1, wherein the fiberglass material is in the form of a plurality of discrete nodules of glass lacking a silicone emulsion.

8. The soilless growing media of claim 1, wherein an average diameter of the fibers of the fiberglass material is in the range of 1 μm to 5 μm.

9. The soilless growing media of claim 1, wherein the soilless growing media is able to hold an increased amount of available water from 1 kPa to 10 kPa as compared to an otherwise identical soilless growing media comprising only the natural material.

10. The soilless growing media of claim 1, wherein the soilless growing media exhibits an increased hydraulic conductivity from 10 kPa to 40 kPa as compared to an otherwise identical soilless growing media comprising only the natural material.

11. The soilless growing media of claim 1, wherein the soilless growing media exhibits a decreased amount of unavailable water from ≥10 kPa, as compared to an otherwise identical soilless growing media comprising only the natural material.

12. The soilless growing media of claim 1, wherein the soilless growing media exhibits a decreased dry bulk density, as compared to an otherwise identical soilless growing media comprising only the natural material.

13. The soilless growing media of claim 1, wherein the soilless growing media exhibits a decreased wet bulk density, as compared to an otherwise identical soilless growing media comprising only the natural material.

14. The soilless growing media of claim 1, wherein the soilless growing media exhibits improved wettability, as compared to an otherwise identical soilless growing media comprising only the natural material.
